(19) United States
(12) Patent Application Publication
(10) Pub. No.: US 2019/0151061 A1
(43) Pub. Date: May 23, 2019

(54) ModularPoweredToothbrush

(71) Applicant: Kenyan Traille, Lawrenceville, GA (US)

(72) Inventor: Kenyan Traille, Lawrenceville, GA (US)

(21) Appl. No.: 15/821,821

(22) Filed: Nov. 23, 2017

(51) Int. Cl. A61D 5/00; A46B 5/00; A46B 13/02; A46B 9/04

(52) U.S. Cl. CPC A61D 5/00; A46B 5/0095; A46B 2200/1066; A46B 9/04; A46B 13/02

(57) ABSTRACT

A cleaning brush having a plurality configuration, wherein interchangeable heads are specific to a molar or canine cleaner. The molar cleaner is configured with two simultaneously rotating bristle surfaces, powered by synchronous gears. The conical shape cleaner is configured with a narrow angle at its' base and a wider angle at its' peripheral opening. The conical cleaner houses cleaning bristles affixed to a hardened exterior comprising varied interchangeable sizes. A configuration accomplished via threads at the base of desired head, and the tip of a common handle, where handle has a motor, shaft, and synchronous gears, necessary to provide power to actuate configured base and head.

### TECHNICAL FIELD OF THE INVENTION

The inventive field generally relates to cleaning brushes, powered, but more significantly to pet toothbrushes.

### BACKGROUND OF THE INVENTION

Pet owners over the years have attempted to solve the nuances of cleaning a dogs' teeth with different brushes, gadgets, chew toys, and dental treats. A dog's mouth is distinct in nature having both canines and molars, and thus the continued employment of flat bristled brushes with identical features as human toothbrushes, yields the same ineffective cleaning every single time. Pet owners can only find comfort in taking their pets to the dentist for an expensive cleaning as most dogs do not like chewing on dental toys, or gadgets meant for cleaning their teeth.

This design takes an approach to solve those issues by designing a cleaning solution specific for a dogs' tooth

### SUMMARY

The inventive matter while having a general classification as a powered tooth brush for pets, is very distinct in the design concept, having the capability to be configured in either of two desired variations, to effectively clean a molar or canine shaped tooth. This design gives special consideration to the unique characteristics of a dogs' teeth and aims at solving the nuances of employing ineffective devices to properly clean the teeth. The design has a conical shaped cleaner with bristles in the hollowed cavity, where a pet's tooth is surrounded by the bristles as the cone rotates and cleans. The second configuration has two cleaning bristle surfaces that spins simultaneously on the outer surface of the tooth to provide the necessary cleaning action.

### DETAILED DESCRIPTION OF EMBODIMENTS

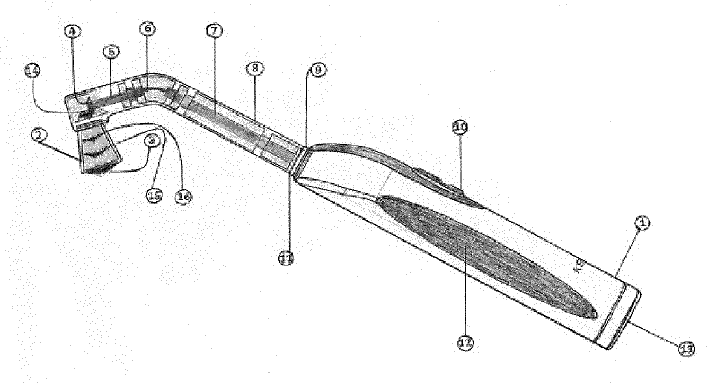

FIG. 1

the primary configuration, itemizes numerical listings on the varied parts for said configuration where

1. Is base common handle manufactured from a plastic material that serves as the main body for apparatus and houses a battery powered shunt motor that turns

7. main drive shaft that interconnects and produces the power for

6. drive, spring, metal flexible at angled neck of brush

5. propels planetary gear 4. orientated ninety degrees to 14. interconnected second planetary gear at the base of

2. the main Conical Cleaner that encases and cleans the canine by rotating about three hundred sixty degrees by

3. bristles contacting the surface of the canine arranged in rows 15. bristles intermediary and 16. bristles base made possible by 8. the main neck housing which interconnects at 9. to base at common handle 1.

10. switch, rubber powers on and off the unit 11. rubber seal, 12. rubber grip support and 13. cap screw

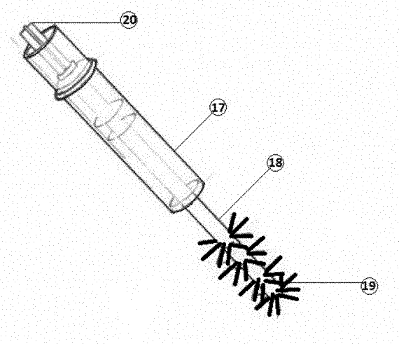

FIG. 2

The secondary configuration consist of

17. head alternate cleaning in secondary configuration for cleaning the molars

18. shaft bristle holder

19. bristles exposed and rotates

20. shaft interconnect hex that allows for connection to 1. common handle at 9. base neck

### BRIEF DESCRIPTIONS OF DRAWINGS

### FIG. 1

Shows the primary configuration of the brush assembly, where the Conical Cleaner is affixed to the common base, serving to provide rotating power to both FIG. 1 and an alternate configuration FIG. 2

In a primary configuration FIG. 1, the Conical Cleaner has bristles oriented inward, that rotates three hundred sixty degrees around the canine to provide effective cleaning.

### FIG. 2

Shows the secondary configuration of the brush assembly, where the opened bristle cleaner is affixed to the main drive shaft and in this configuration serves to clean the molar.

In this configuration, the molar cleaner has exposed bristles designed to effectively affect the inner and outer molar surfaces for cleaning.

This configuration replaces the conical cleaner configuration referenced in FIG. 1 and uses the common base to achieve similar rotating force.

The invention claimed is:

1. A modular toothbrush having varied configurations with attachments (2), and (17) to a common drive handle (1), having a motor of quiet design encased within; helical shafts arranged longitudinal to the body of said common handle with miniature transfer gears (4), and (14), arranged at desirable angle to transfer power to a conical cleaner (2) in a primary configuration.

2. A Modular toothbrush as defined in claim 1, further configured with molar cleaner (2) that receives power from, and is only operable upon configuration with common handle in a secondary configuration

3. A Modular toothbrush as defined in claim 2, where the molar cleaner has oscillating bristles (19) configured ideally at different degrees, on a rotating shaft (18) offset the horizontal axis of rotating shaft, and rotates 360 degrees about either side of the molar, to stimulate and clean the canine tooth.

4. A Modular toothbrush as defined in claim 1, further configured with a conical cleaner (2) that receives power from, and is only operable upon configuration with common handle.

5. A Modular toothbrush as defined in claim 4, where the conical cleaner has inward facing bristles (3) affixed about its' inner cavity, and arranged at desired angle towards wide tapered opening, enabling slight protrusion to increase the surface cleaning area.

6. A Modular toothbrush as defined in claim 5, where said configurations and bristles rotates about the canine to produce the necessary cleaning

7. A Modular toothbrush as defined in claim 6, where the conical cleaner is outfitted with different sized rows of bristle to effectively encase the canine

8. The Modular toothbrush as defined in claim 7, wherein configuration is interchanged at (9), to facilitate said interchanging of desired cleaning head.
